(19) United States
(12) Patent Application Publication
(10) Pub. No.: US 2021/0357145 A1
(43) Pub. Date: Nov. 18, 2021

(54) DATA WRITING METHOD, MEMORY STORAGE DEVICE AND MEMORY CONTROL CIRCUIT UNIT

(71) Applicant: PHISON ELECTRONICS CORP., Miaoli (TW)

(72) Inventors: Wei-Cheng Li, Miaoli County (TW); Yu-Chung Shen, Miaoli County (TW); Wei-Liang Huang, Hsinchu County (TW); Chao-Kai Zhang, Miaoli County (TW)

(73) Assignee: PHISON ELECTRONICS CORP., Miaoli (TW)

(21) Appl. No.: 16/920,446

(22) Filed: Jul. 3, 2020

(30) Foreign Application Priority Data
May 18, 2020 (TW) 109116413

(51) Int. Cl. G06F 3/06

(52) U.S. Cl. CPC G06F 3/0655; G06F 3/0604; G06F 3/0679

(57) ABSTRACT

A data writing method for a rewritable non-volatile memory module is provided according to embodiments of the disclosure. The method includes: writing first-type data into a first physical unit at a first write speed; and writing second-type data into a second physical unit at a second write speed. The first-type data is different from the second-type data, and the first write speed is different from the second write speed.

### CROSS-REFERENCE TO RELATED APPLICATION

This application claims the priority benefit of Taiwan application serial no. 109116413, filed on May 18, 2020. The entirety of the above-mentioned patent application is hereby incorporated by reference herein and made a part of this specification.

### BACKGROUND

### 1. Technology Field

The disclosure relates to a data writing technique, and more particularly, to a data writing method for a rewritable non-volatile memory module, a memory control circuit unit and a memory storage device.

### 2. Description of Related Art

The markets of digital cameras, cellular phones, and MP3 players have expanded rapidly in recent years, resulting in escalated demand for storage media by consumers. The characteristics of data non-volatility, low power consumption, and compact size make a rewritable non-volatile memory module (e.g., flash memory) ideal to be built in the portable multi-media devices as cited above.

In general, data stored in the rewritable non-volatile memory module may generate error bits due to various factors (e.g., current leakages, programming failures and damages on memory cells, and etc.). For example, when operating at a high speed, a memory storage device having the rewritable non-volatile memory module needs to consume a large amount of energy which causes its temperature to be overly high. Consequently, the memory storage device is prone to damages so that the number of error bits in the data may easily exceed the number of correctable error bits. Accordingly, as the data containing the error bits cannot be corrected, the data will be lost. In addition, the probability of data errors in rewritable non-volatile memory modules increases as the service life increases. Based on this, finding a way to maintain an access performance of the memory storage device while ensuring a data accuracy is the goal of those skilled in the art.

### SUMMARY

The disclosure provides a memory writing method, a memory storage device and a memory control circuit unit, which are capable of solving the problems described above and effectively improving data retention and data accuracy.

A data writing method for a rewritable non-volatile memory module is provided according to embodiments of the disclosure. The rewritable non-volatile memory module includes a plurality of physical units, and the physical units include a first physical unit and a second physical unit. The data writing method includes: writing first-type data into the first physical unit at a first write speed; and writing second-type data into the second physical unit at a second write speed. The first-type data is different from the second-type data, and the first write speed is different from the second write speed.

An exemplary embodiment of the disclosure further provides a memory storage device, which includes a connection interface unit, a rewritable non-volatile memory module and a memory control circuit unit. The connection interface unit is configured to couple to a host system. The rewritable non-volatile memory module includes a plurality of physical units, and the physical units include a first physical unit and a second physical unit. The memory control circuit unit is coupled to the connection interface unit and the rewritable non-volatile memory module. The memory control circuit unit is configured to write first-type data into the first physical unit at a first write speed. The memory control circuit unit is further configured to write second-type data into the second physical unit at a second write speed. The first-type data is different from the second-type data, and the first write speed is different from the second write speed.

Another exemplary embodiment of the disclosure provides a memory control circuit unit, which is configured to control a rewritable non-volatile memory module. The memory control circuit unit includes a host interface, a memory interface and a memory management circuit. The host interface is configured to couple to a host system. The memory interface is configured to couple to the rewritable non-volatile memory module. The memory management circuit is coupled to the host interface and the memory interface. The memory management circuit is configured to write first-type data into the first physical unit at a first write speed. The memory management circuit is further configured to write second-type data into the second physical unit at a second write speed. The first-type data is different from the second-type data, and the first write speed is different from the second write speed.

Based on the above, in an exemplary embodiment of the disclosure, by writing different types of data at different speeds, the data accuracy can be ensured while maintaining the data access performance.

To make the aforementioned more comprehensible, several embodiments accompanied with drawings are described in detail as follows.

It should be understood, however, that this Summary may not contain all of the aspects and embodiments of the present disclosure, is not meant to be limiting or restrictive in any manner, and that the disclosure as disclosed herein is and will be understood by those of ordinary skill in the art to encompass obvious improvements and modifications thereto.

### BRIEF DESCRIPTION OF THE DRAWINGS

FIG. 1 is a schematic diagram illustrating a host system, a memory storage device and an I/O (input/output) device according to an exemplary embodiment of the disclosure.

FIG. 2 is a schematic diagram illustrating a host system, a memory storage device and an I/O device according to another exemplary embodiment of the disclosure.

FIG. 3 is a schematic diagram illustrating a host system and a memory storage device according to another exemplary embodiment of the disclosure.

FIG. 4 is a schematic block diagram illustrating a memory storage device according to an exemplary embodiment of the disclosure.

FIG. 5 is a schematic block diagram illustrating a memory control circuit unit according to an exemplary embodiment of the disclosure.

FIG. 6 is a schematic diagram illustrating management of a rewritable non-volatile memory module according to an exemplary embodiment of the disclosure.

FIG. 7 is a schematic block diagram illustrating a clock signal output circuit according to an exemplary embodiment.

FIG. 8 is a schematic diagram illustrating clock signals corresponding to different write speeds according to an exemplary embodiment.

FIG. 9 is a flowchart illustrating a data writing method according to an exemplary embodiment.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

Embodiments of the disclosure may comprise any one or more of the novel features described herein, including in the detailed description, and/or shown in the drawings. As used herein, “at least one,” “one or more,” and “and/or” are open-ended expressions that are both conjunctive and disjunctive in operation. For instance, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein.

In general, a memory storage device (a.k.a. a memory storage system) includes a rewritable non-volatile memory module and a controller (a.k.a. a control circuit). The memory storage device usually operates together with a host system so the host system can write data into the memory storage device or read data from the memory storage device.

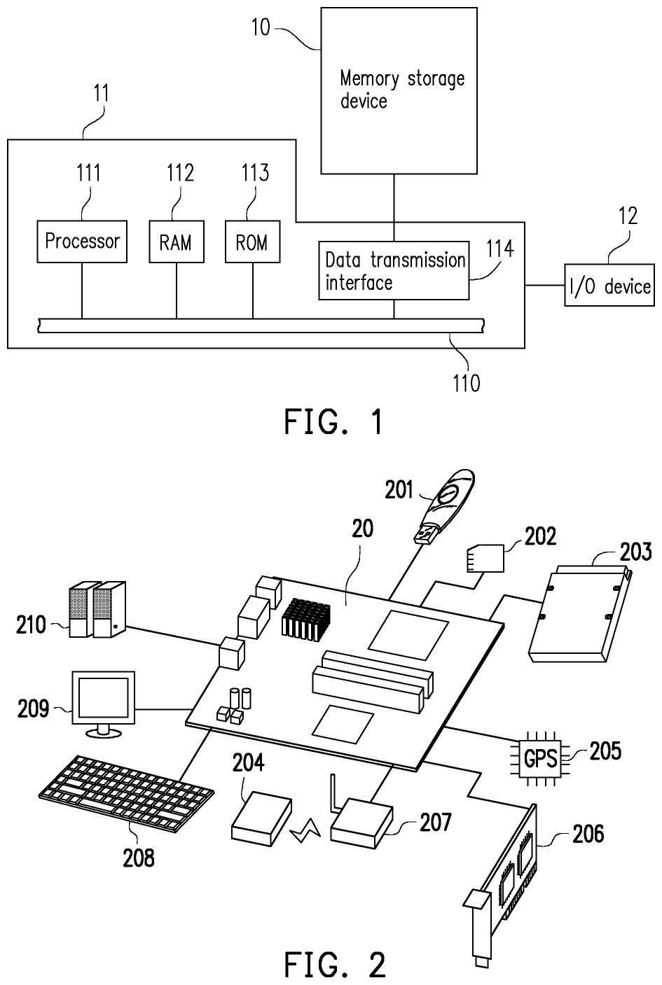

FIG. 1 is a schematic diagram illustrating a host system, a memory storage device and an I/O (input/output) device according to an exemplary embodiment of the disclosure. FIG. 2 is a schematic diagram illustrating a host system, a memory storage device and an I/O device according to another exemplary embodiment of the disclosure.

Referring to FIG. 1 and FIG. 2, a host system 11 generally includes a processor 111, a RAM (random access memory) 112, a ROM (read only memory) 113 and a data transmission interface 114. The processor 111, the RAM 112, the ROM 113 and the data transmission interface 114 are coupled to a system bus 110.

In this exemplary embodiment, the host system 11 is coupled to a memory storage device 10 through the data transmission interface 114. For example, the host system 11 can store data into the memory storage device 10 or read data from the memory storage device 10 via the data transmission interface 114. Further, the host system 11 is coupled to an I/O device 12 via the system bus 110. For example, the host system 11 can transmit output signals to the I/O device 12 or receive input signals from the I/O device 12 via the system bus 110.

In the present exemplary embodiment, the processor 111, the RAM 112, the ROM 113 and the data transmission interface 114 may be disposed on a main board 20 of the host system 11. The number of the data transmission interface 114 may be one or more. Through the data transmission interface 114, the main board 20 may be coupled to the memory storage device 10 in a wired manner or a wireless manner. The memory storage device 10 may be, for example, a flash drive 201, a memory card 202, a SSD (Solid State Drive) 203 or a wireless memory storage device 204. The wireless memory storage device 204 may be, for example, a memory storage device based on various wireless communication technologies, such as a NFC (Near Field Communication) memory storage device, a WiFi (Wireless Fidelity) memory storage device, a Bluetooth memory storage device, a BLE (Bluetooth low energy) memory storage device (e.g., iBeacon). Further, the main board 20 may also be coupled to various I/O devices including a GPS (Global Positioning System) module 205, a network interface card 206, a wireless transmission device 207, a keyboard 208, a monitor 209 and a speaker 210 through the system bus 110. For example, in an exemplary embodiment, the main board 20 can access the wireless memory storage device 204 via the wireless transmission device 207.

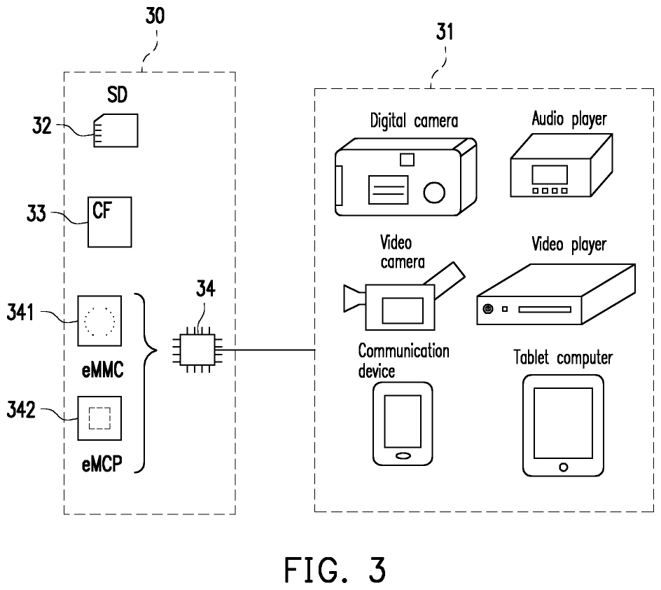

In an exemplary embodiment, aforementioned host system may be any system capable of substantially cooperating with the memory storage device for storing data. Although the host system is illustrated as a computer system in foregoing exemplary embodiment, nonetheless, FIG. 3 is a schematic diagram illustrating a host system and a memory storage device according to another exemplary embodiment of the disclosure. Referring to FIG. 3, in another exemplary embodiment, a host system 31 may also be a system such as a digital camera, a video camera, a communication device, an audio player, a video player or a tablet computer, whereas a memory storage device 30 may be various non-volatile memory storage devices used by the host system, such as a SD (Secure Digital) card 32, a CF (Compact Flash) card 33 or an embedded storage device 34. The embedded storage device 34 includes various embedded storage devices capable of directly coupling a memory module onto a substrate of the host system, such as an eMMC (embedded Multi Media Card) 341 and/or an eMCP (embedded Multi Chip Package) storage device 342.

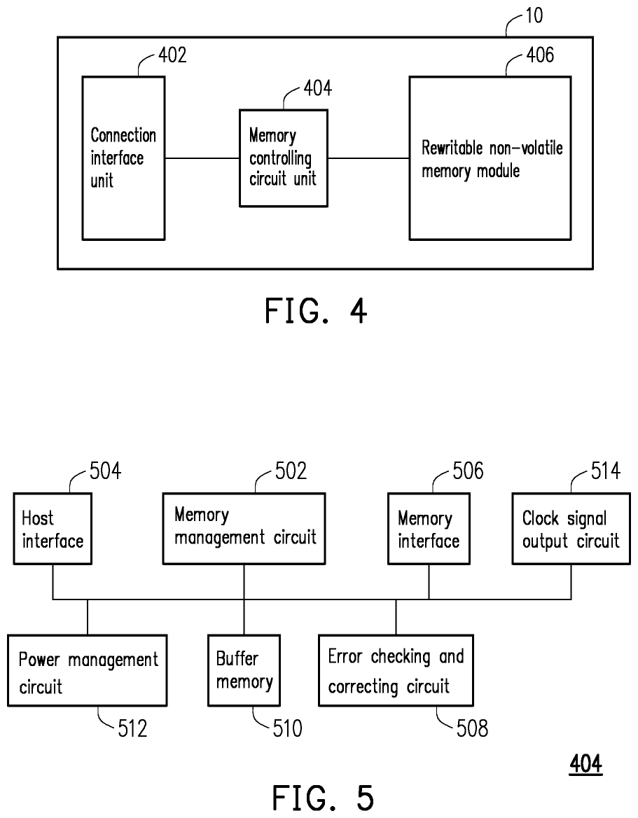

FIG. 4 is a schematic block diagram illustrating a memory storage device according to an exemplary embodiment of the disclosure. Referring to FIG. 4, the memory storage device 10 includes a connection interface unit 402, a memory control circuit unit 404 and a rewritable non-volatile memory module 406.

The connection interface unit 402 is configured to couple to the memory storage device 10 to the host system 11. The memory storage device 10 can communicate with the host system 11 through the connection interface unit 402. In the present exemplary embodiment, the connection interface unit 402 is compatible with a SATA (Serial Advanced Technology Attachment) standard. Nevertheless, it should be understood that the disclosure is not limited in this regard. The connection interface unit 402 may also be compatible with a PATA (Parallel Advanced Technology Attachment) standard, an IEEE (Institute of Electrical and Electronic Engineers) 1394 standard, a PCI Express (Peripheral Component Interconnect Express) interface standard, a USB (Universal Serial Bus) standard, a SD interface standard, a UHS-I (Ultra High Speed-I) interface standard, a UHS-II (Ultra High Speed-II) interface standard, a MS (Memory Stick) interface standard, a MCP interface standard, a MMC interface standard, an eMMC interface standard, a UFS (Universal Flash Storage) interface standard, an eMCP interface standard, a CF interface standard, an IDE (Integrated Device Electronics) interface standard or other suitable standards. The connection interface unit 402 and the memory control circuit unit 404 may be packaged into one chip, or the connection interface unit 402 is distributed outside of a chip containing the memory control circuit unit 404.

The memory control circuit unit 404 is configured to execute a plurality of logic gates or control commands which are implemented in a hardware form or in a firmware form and perform operations of writing, reading or erasing data in the rewritable non-volatile memory storage module 406 according to the commands of the host system 11.

The rewritable non-volatile memory module 406 is coupled to the memory control circuit unit 404 and configured to store data written from the host system 11. The rewritable non-volatile memory module 406 may be a SLC (Single Level Cell) NAND flash memory module (i.e., a flash memory module capable of storing one bit in one memory cell), an MLC (Multi Level Cell) NAND flash memory module (i.e., a flash memory module capable of storing two bits in one memory cell), a TLC (Triple Level Cell) NAND flash memory module (i.e., a flash memory module capable of storing three bits in one memory cell), a Quad Level Cell (MLC) NAND-type flash memory module (i.e., a flash memory module capable of storing four bits in one memory cell), other flash memory modules or other memory modules having the same features.

In the rewritable non-volatile memory module 406, one or more bits are stored by changing a voltage (hereinafter, also known as a threshold voltage) of each of the memory cells. More specifically, in each of the memory cells, a charge trapping layer is provided between a control gate and a channel. Amount of electrons in the charge trapping layer may be changed by applying a write voltage to the control gate thereby changing the threshold voltage of the memory cell. This operation of changing the threshold voltage of the memory cell is also known as “writing data into the memory cell” or “programming the memory cell”. With changes in the threshold voltage, each of the memory cells in the rewritable non-volatile memory module 406 has a plurality of storage states. The storage state to which the memory cell belongs may be determined by applying a read voltage to the memory cell, so as to obtain the one or more bits stored in the memory cell.

In this exemplary embodiment, the memory cells of the rewritable non-volatile memory module 406 may constitute a plurality of physical programming units, and the physical programming units can constitute a plurality of physical erasing units. Specifically, the memory cells on the same word line may constitute one or more of the physical programming units. If each of the memory cells can store two or more bits, the physical programming units on the same word line may be at least classified into a lower physical programming unit and an upper physical programming unit. For instance, a least significant bit (LSB) of one memory cell belongs to the lower physical programming unit, and a most significant bit (MSB) of one memory cell belongs to the upper physical programming unit. Generally, in the MLC NAND flash memory, a write speed of the lower physical programming unit is higher than a write speed of the upper physical programming unit, and/or a reliability of the lower physical programming unit is higher than a reliability of the upper physical programming unit.

In this exemplary embodiment, the physical programming unit is the minimum unit for programming. That is, the physical programming unit is the minimum unit for writing data. For example, the physical programming unit may be a physical page or a physical sector. If the physical programming unit is the physical page, these physical programming units may include a data bit area and a redundancy bit area. The data bit area contains multiple physical sectors configured to store user data, and the redundant bit area is configured to store system data (e.g., management data such as an error correcting code, etc.). In this exemplary embodiment, the data bit area contains 32 physical sectors, and a size of each physical sector is 512 bytes (B). However, in other exemplary embodiments, the data bit area may also contain 8, 16 physical sectors or different number (more or less) of the physical sectors, and the size of each physical sector may also be greater or smaller. On the other hand, the physical erasing unit is the minimum unit for erasing. Namely, each physical erasing unit contains the least number of memory cells to be erased together. For instance, the physical erasing unit is a physical block.

FIG. 5 is a schematic block diagram illustrating a memory control circuit unit according to an exemplary embodiment of the disclosure. Referring to FIG. 5, the memory control circuit unit 404 includes a memory management circuit 502, a host interface 504 and a memory interface 506.

The memory management circuit 502 is configured to control overall operation of the memory control circuit unit 404. Specifically, the memory management circuit 502 has a plurality of control commands. When the memory storage device 10 operates, the control commands are executed to perform various operations such as data writing, data reading and data erasing. Hereinafter, operations of the memory management circuit 502 are described as equivalent to operations of the memory control circuit unit 404.

In this exemplary embodiment, the control commands of the memory management circuit 502 are implemented in form of firmware. For instance, the memory management circuit 502 has a microprocessor unit (not illustrated) and a ROM (not illustrated), and the control commands are burned into the ROM. When the memory storage device 10 operates, the control commands are executed by the microprocessor to execute operations of writing, reading or erasing data.

In another exemplary embodiment, the control commands of the memory management circuit 502 may also be stored as program codes in a specific area (e.g., the system area in a memory exclusively used for storing system data) of the rewritable non-volatile memory module 406. In addition, the memory management circuit 502 has a microprocessor unit (not illustrated), a ROM (not illustrated) and a RAM (not illustrated). More particularly, the ROM has a boot code, which is executed by the microprocessor unit to load the control commands stored in the rewritable non-volatile memory module 406 to the RAM of the memory management circuit 502 when the memory control circuit unit 404 is enabled. Then, the control commands are executed by the microprocessor unit to execute operations, such as writing, reading or erasing data.

Further, in another exemplary embodiment, the control commands of the memory management circuit 502 may also be implemented in form of hardware. For example, the memory management circuit 502 includes a microprocessor, a memory cell management circuit, a memory writing circuit, a memory reading circuit, a memory erasing circuit and a data processing circuit. The memory cell management circuit, the memory writing circuit, the memory reading circuit, the memory erasing circuit and the data processing circuit are coupled to the microprocessor. The memory cell management circuit is configured to manage the memory cells of a memory cell group of the rewritable non-volatile memory module 406. The memory writing circuit is configured to issue a write command sequence for the rewritable non-volatile memory module 406 to write data into the rewritable non-volatile memory module 406. The memory reading circuit is configured to issue a read command sequence for the rewritable non-volatile memory module 406 to read data from the rewritable non-volatile memory module 406. The memory erasing circuit is configured to issue an erase command sequence for the rewritable non-volatile memory module 406 to erase data from the rewritable non-volatile memory module 406. The data processing circuit is configured to process data to be written into the rewritable non-volatile memory module 406 and data read from the rewritable non-volatile memory module 406. Each of the write command sequence, the read command sequence and the erase command sequence may include one or more program codes or command codes, and instruct the rewritable non-volatile memory module 406 to perform the corresponding operations, such as writing, reading and erasing. In an exemplary embodiment, the memory management circuit 502 may further give command sequence of other types to the rewritable non-volatile memory module 406 for instructing to perform the corresponding operations.

The host interface 504 is coupled to the memory management circuit 502. The memory management circuit 502 can communicate with the host system 11 through the host interface 504. The host interface 504 may be used to receive and identify commands and data transmitted by the host system 11. For example, the commands and the data transmitted by the host system 11 may be transmitted to the memory management circuit 502 via the host interface 504. In addition, the memory management circuit 502 can transmit data to the host system 11 via the host interface 504. In this exemplary embodiment, the host interface 504 is compatible with the SATA standard. Nevertheless, it should be understood that the disclosure is not limited in this regard. The host interface 504 may also compatible with the PATA standard, the IEEE 1394 standard, the PCI Express standard, the USB standard, the SD standard, the UHS-I standard, the UHS-II standard, the MS standard, the MMC standard, the eMMC standard, the UFS standard, the CF standard, the IDE standard, or other suitable standards for data transmission.

The memory interface 506 is coupled to the memory management circuit 502 and configured to access the rewritable non-volatile memory module 406. In other words, data to be written into the rewritable non-volatile memory module 406 is converted into a format acceptable by the rewritable non-volatile memory module 406 via the memory interface 506. Specifically, if the memory management circuit 502 intends to access the rewritable non-volatile memory module 406, the memory interface 506 sends corresponding command sequences. For example, the command sequences may include the write command sequence as an instruction for writing data, the read command sequence as an instruction for reading data, the erase command sequence as an instruction for erasing data, and other corresponding command sequences as instructions for performing various memory operations (e.g., changing read voltage levels or performing a garbage collection procedure). These command sequences are generated by the memory management circuit 502 and transmitted to the rewritable non-volatile memory module 406 via the memory interface 506, for example. The command sequences may include one or more signals, or data transmitted in the bus. The signals or the data may include command codes and program codes. For example, information such as identification codes and memory addresses are included in the read command sequence;

In an exemplary embodiment, the memory control circuit unit 404 further includes an error checking and correcting circuit 508, a buffer memory 510 and a power management circuit 512.

The error checking and correcting circuit 508 is coupled to the memory management circuit 502 and configured to execute an error checking and correcting operation to ensure the correctness of data. Specifically, when the memory management circuit 502 receives the writing command from the host system 11, the error checking and correcting circuit 508 generates an error correcting code (ECC) or an error detecting code (EDC) for data corresponding to the writing command, and the memory management circuit 502 writes data and the ECC or the EDC corresponding to the writing command to the rewritable non-volatile memory module 406. Then, when the memory management circuit 502 reads the data from the rewritable non-volatile memory module 406, the corresponding ECC and/or the EDC are also read, and the error checking and correcting circuit 508 executes the error checking and correcting operation on the read data based on the ECC and/or the EDC.

The buffer memory 510 is coupled to the memory management circuit 502 and configured to temporarily store data and commands from the host system 11 or data from the rewritable non-volatile memory module 406. The power management unit 512 is coupled to the memory management circuit 502 and configured to control a power of the memory storage device 10.

In an exemplary embodiment, the memory control circuit unit 404 further includes a clock signal output circuit 514. The clock signal output circuit 514 is coupled the memory management circuit 502, the host interface 504, the memory interface 506, the error checking and correcting circuit 508, the buffer memory 510 and the power management circuit 512. The clock signal output circuit 514 is configured to output a plurality of clock signals having the same or different frequencies to the memory management circuit 502, the host interface 504, the memory interface 506, the error checking and correcting circuit 508, the buffer memory 510 and the power management circuit 512. If a circuit (e.g., the memory management circuit 502) includes multiple internal circuits, the clock signal output circuit 514 may also provide the clock signals having the same or different frequencies to these internal circuits, respectively.

In an exemplary embodiment, the rewritable non-volatile memory module 406 of FIG. 4 is also known as a flash memory module; the memory control circuit unit 404 is also known as a flash memory controller for controlling the flash memory module; and/or the memory management circuit 502 of FIG. 5 is also known as a flash memory management circuit.

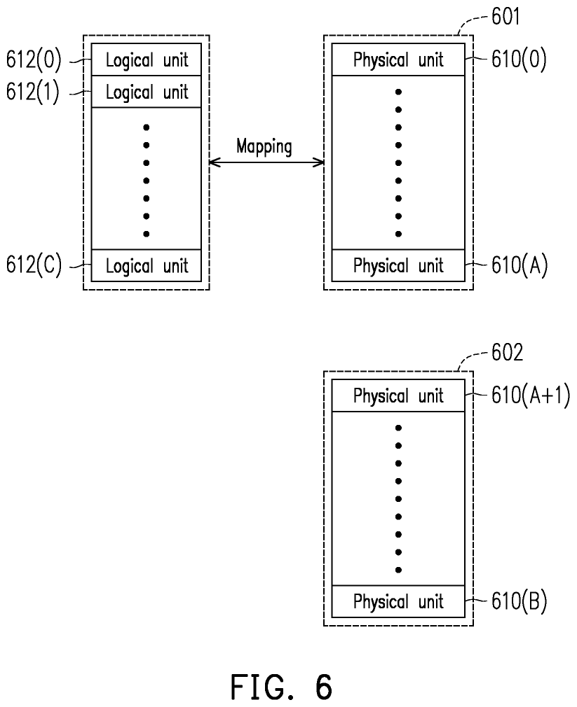

FIG. 6 is a schematic diagram illustrating management of a rewritable non-volatile memory module according to an exemplary embodiment of the disclosure.

Referring to FIG. 6, the memory management circuit 502 can logically group the physical units 610(0) to 610(B) of the rewritable non-volatile memory module 406 into a plurality of areas such as a storage area 601 and a system area 602.

The physical units 610(0) to 610(A) in the storage area 601 are configured to store data from the host system 11. The storage area 601 stores valid data and invalid data. For example, when the host system intends to delete one valid data, the data being deleted may still be stored in the storage area 601 but marked as the invalid data. In the following exemplary embodiment, the physical unit not storing the valid data is also known as a spare physical unit. For example, the physical unit being erased becomes the spare physical unit. Further, in the following exemplary embodiment, the physical unit storing the valid data is also known as a non-spare physical unit.

In an exemplary embodiment, if there are damaged physical units in the storage area 601 or the system area 602, the physical units in the storage area 601 may also be used to replace the damaged physical units. If there are no available physical units in the storage area 601 for replacing the damaged physical units, the memory management circuit 502 can announce that the memory storage device 10 is in a write protect status, so that data can no longer be written thereto.

The physical units in the system area 602 are configured to record system information including information related to manufacturer and model of a memory chip, a number of physical erasing units in the memory chip, a number of the physical programming unit in each physical erasing unit, and so forth.

In an exemplary embodiment, amounts of the physical units in the storage area 601 and the system area 602 may be different based on different memory specifications. In addition, it should be understood that, during operations of the memory storage device 10, grouping relations of the physical units associated to the storage area 601 and the system area 602 may be dynamically changed. For example, when damaged physical units in the system area 602 are replaced by the physical units in the storage area 601, the physical units originally from the storage area 601 are then associated to the system area 602.

In the present exemplary embodiment, each physical unit refers to one physical erasing unit. However, in another exemplary embodiment, one physical unit may also refer to one physical address, one physical programming unit, or a composition of a plurality of continuous or discontinuous physical addresses. The memory management circuit 502 assigns logical units 612(0) to 612(C) for mapping to the physical units 610(0) to 610(A) in the storage area 601. In the present exemplary embodiment, each logical unit refers to one logical address. However, in another exemplary embodiment, each logical unit may also refer to one logical programming unit, one logical erasing unit or a composition of a plurality of continuous or discontinuous logical addresses. In addition, each of the logical units 612(0) to 612(C) may also be mapped to one or more physical units.

The memory management circuit 502 records a mapping relation (a.k.a. a logical-physical address mapping relation) between the logical units and the physical units into at least one logical-physical address mapping table. When the host system 11 intends to read the data from the memory storage device 10 or write the data into the memory storage device 10, the memory management circuit 502 can perform a data accessing operation on the memory storage device 10 according to the logical-physical address mapping table.

In this exemplary embodiment, the memory management circuit 502 determines a speed for writing data into the rewritable non-volatile memory module according to a data type. Specifically, in an exemplary embodiment of the disclosure, the data type used by the memory management circuit 502 to determine a write speed includes user data from the host system 11 (a.k.a. first-type data) and management data for managing the rewritable non-volatile memory module 406 (a.k.a. second-type data). Here, the management data is, for example, used in one of a wear leveling operation, a bad block managing operation and a mapping table maintaining operation of the rewritable non-volatile memory module 406.

Specifically, the wear leveling operation may include, for example, a data read event and a data write event that move data between the physical units of different wear levels. The bad block management operation may include, for example, bad physical erasing units in the rewritable non-volatile memory module 406 recorded by the memory management circuit 502 according to bad block information, which may be used to create or maintain a write event of a bad block management table. The mapping table maintenance operation is used ensure the mapping relation of the logical units and the physical units described above can maintain correct with operations of the memory storage device 10 so that the data writing event of the logical-to-physical address mapping table in the rewritable non-volatile memory module 406 may be updated according to the data in the buffer memory 510. However, the management data (the second-type data) for managing the rewritable non-volatile memory module 406 in the disclosure is not limited to the above. For example, the management data may be used in any management operation performed by the memory management circuit 502. The management operation also includes operations for releasing the spare physical units, such as data merging operation.

In this exemplary embodiment, the memory management circuit 502 can determine whether data to be currently written into the rewritable non-volatile memory module 406 is the first-type data (i.e., the user data) or the second-type data (i.e., the management data) according to the received write command, and write the data into the rewritable non-volatile memory module 406 at a corresponding speed according to the data type. For instance, the memory management circuit 502 writes the first-type data into a physical unit (a.k.a. a first physical unit) in the rewritable non-volatile memory module 406 at a first write speed, and writes the second-type data into a physical unit (a.k.a. a second physical unit) in the rewritable non-volatile memory module 406 at a second write speed. Here, the first write speed is different from the second write speed.

Particularly, in an exemplary embodiment of the disclosure, the first write speed is greater than the second write speed. In other words, when writing the first-type data, the memory management circuit 502 writes the first-type data into the first physical unit in the rewritable non-volatile memory module 406 at a high speed, for example. Further, when the memory management circuit 502 intends to write the second-type data, the memory management circuit 502 lowers the write speed for writing the second-type data in the second physical unit in the rewritable non-volatile memory module 406. Here, the first physical unit is, for example, a physical unit belonging to the storage area 601, and the second physical unit is, for example, a physical unit belonging to the system area. In other words, in the present exemplary embodiment of the disclosure, the memory management circuit 502 writes the user data from the host system 11 into the physical unit in the storage area 601, and writes the management data for managing the rewritable non-volatile memory module 406 into the physical unit in the system area 602.

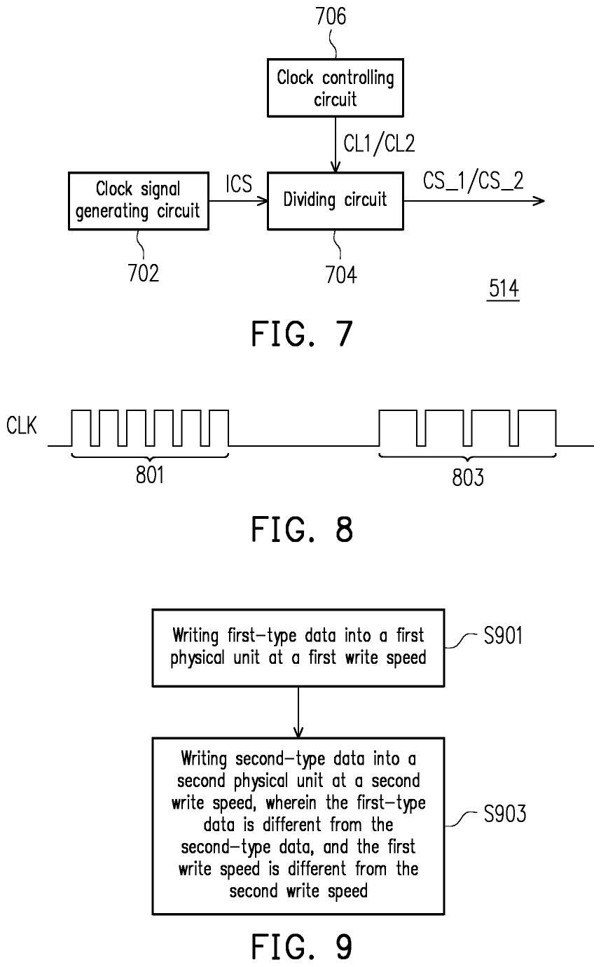

FIG. 7 is a schematic block diagram illustrating a clock signal output circuit according to an exemplary embodiment. It should be understood that, a structure of the clock signal output circuit depicted in FIG. 7 is only an example, and the disclosure is not limited thereto. FIG. 8 is a schematic diagram illustrating clock signals corresponding to different write speeds according to an exemplary embodiment.

Here, FIG. 7 and FIG. 8 are taken as examples to illustrate a method for writing different types of data at different speeds in an exemplary embodiment of the disclosure. Referring to FIG. 7, the clock signal output circuit 514 includes a clock signal generating circuit 702, a dividing circuit 704 and a clock controlling circuit 706. The clock signal generating circuit 702 is configured to provide an initial clock signal ICS. For example, the clock signal generating circuit 702 includes an oscillator. The dividing circuit 704 is coupled to the clock signal generating circuit 702, and configured to output clock signals divided according to the initial clock signal ICS. Here, the number of the dividing circuits 704 may be more than one, and the disclosure is not limited thereto. In this exemplary embodiment, the dividing circuit 704 is configured to provide clock signals CS_1 (a.k.a. a first clock signal) and CS_2 (a.k.a. a second clock signal) to the memory management circuit 502. That is to say, in this exemplary embodiment, the first clock signal CS_1 and the second clock signal CS_2 are the clock signals provided for the memory management circuit 502 to write the different types of data at the different write speeds. The clock control circuit 706 is coupled to the dividing circuit 704 and configured to control the dividing circuit 704. The clock control circuit 706 can control frequencies of the clock signals outputted by the dividing circuit 704.

In this exemplary embodiment, the first clock signal CS_1 and the second clock signal CS_2 are the clock signals provided for the memory management circuit 502 to write the different types of data at the different write speeds. Therefore, when writing the first-type data (i.e., the user data) into the first physical unit in the storage area 601, the memory management circuit 502 writes the first-type data into the first physical unit at the first write speed by using a clock frequency (a.k.a. a first clock frequency) corresponding to the first clock signal CS_1. When writing the second-type data (i.e., the management data) into the second physical unit in the system area 602, the memory management circuit 502 writes the second-type data into the second physical unit at the second write speed by using a clock frequency (a.k.a. a second clock frequency) corresponding to the second clock signal CS_2. Here, the first clock frequency is different from the second clock frequency.

More specifically, referring to FIG. 7 and FIG. 8, the clock control circuit 706 generates control parameters according to the data type to be currently written by the memory management circuit 502. For example, when the data to be currently written is the first-type data, the clock control circuit 706 generates a first control parameter CL1 to control the dividing circuit 704 to generate a clock signal 801 corresponding to the first clock signal CS_1 so that the memory management circuit 502 can write the first-type data at the first write speed. Later, if the data to be written by the memory management circuit 502 is the second-type data, the clock control circuit 706 generates a second control parameter CL1 to control the dividing circuit 704 to generate a clock signal 803 corresponding to the second clock signal CS_2 so that the memory management circuit 502 can write the second-type data at the second write speed. As shown in FIG. 8, a period of the clock signal 801 is shorter than a period of the clock signal 803. That is, the first clock frequency corresponding to the clock signal 801 is greater than the second clock frequency corresponding to the clock signal 803. For example, in this exemplary embodiment, the first clock frequency corresponding to the clock signal 801 is 200 MHz, and the second clock frequency corresponding to the clock signal 803 is 25 MHz. However, the disclosure does not limit the frequency of the first clock signal CS_1 and the frequency of the second clock signal CS_2. For example, in another exemplary embodiment of the disclosure, the first clock frequency may be a frequency greater than 200 MHz or a frequency less than 200 MHz, and the second clock frequency may be a frequency greater than 25 MHz or a frequency less than 25 MHz.

It is worth noting that, in this exemplary embodiment, the first write speed used by the memory management circuit 502 to write the user data differs from the second write speed used to write the management data by at least five times. In other words, the clock control circuit 706 will control the dividing circuit 704 to output the first clock signal CS_1 and the second clock signal CS_2 based on the above to generate the first clock frequency corresponding to the first write speed and the second clock frequency corresponding to the second write speed. Also, the first clock frequency is greater than the second clock frequency so that the first write speed and the second write speed differ by at least five times. However, the disclosure is not intended to limit a multiple at least by which the first write speed and the second write speed differ from each other, which may be adjusted and set according to different requirements or an execution performance of the memory storage device 10. For example, in another exemplary embodiment, the multiple at least by which the first write speed and the second write speed differ from each other may be set to greater than or less than five times.

Specifically, in the exemplary embodiment of the disclosure, by maintaining the relatively high first write speed to write all the first-type data (i.e., the user data) and reducing it to the second write speed to write the second type data (i.e., the management data) other than the first-type data, the problems that the number of error bits in the data caused by writing the second-type data at the high speed (e.g., the first write speed) is too high and the data retention is reduced can be avoided. For example, when it is intended to analyze and debug the memory storage device 10, the management data in the system area 602 in the rewritable non-volatile memory module 406 needs to be read for debugging (to read record loss information, bad block Information or logical-physical address mapping relation information and other management data). At this time, the management data in the rewritable non-volatile memory module 406 is written at the second write speed which is lower than the first write speed. Therefore, the data stability and data retention of the management data are higher and can be read out smoothly by the memory management circuit 502 to facilitate the analysis and debugging operations. For example, in an exemplary embodiment of the disclosure, the operation of writing the first-type data and the second type data at the different speeds is applicable to analysis, debugging, and reopening operations (e.g., initialization) of the downgrade flash memory.

Further, in the exemplary embodiment of the disclosure, the memory management circuit 502 maintains the first write speed at high speed to write the user data to the rewritable non-volatile memory module 406. Therefore, for the user, an access speed of the memory storage device 10 is maintained at a high speed. In other words, for the user, overall operating performance and operating speed have not decreased. In view of this, through the operation of writing the different types of data at the different speeds in the exemplary embodiment of the disclosure, not only can the data accuracy be effectively ensured, the access performance of the memory storage device can be also be taken into account.

FIG. 9 is a flowchart illustrating a data writing method according to an exemplary embodiment. Referring to FIG. 9, in step S901, the memory management circuit 502 writes first-type data into a first physical unit at a first write speed. Referring to FIG. 9, in step S902, the memory management circuit 502 writes second-type data into a second physical unit at a second write speed. Here, the first-type data is different from the second-type data, and the first write speed is different from the second write speed.

Nevertheless, steps depicted in FIG. 9 are described in detail as above so that related description thereof is omitted hereinafter. It should be noted that, the steps depicted in FIG. 9 may be implemented as a plurality of program codes or circuits, which are not particularly limited in the disclosure. Moreover, the method disclosed in FIG. 9 may be implemented by reference with above exemplary embodiments, or may be implemented separately, which are not particularly limited in the disclosure.

In summary, in the exemplary embodiment of the disclosure, the data writing method, the memory storage device and the memory control circuit unit proposed can write the different types of data into the rewritable non-volatile memory module at the different speeds according to the data type. In this way, the management data for managing the rewritable non-volatile memory module can be written at a reduced speed, thereby achieving the higher data stability and data retention. On the other hand, the user data is written at the high write speed, thereby maintaining an access speed of the memory storage device and improving the overall operating performance. Compared with the traditional method of writing all types of data at the same speed or at high speed, the data writing method in the exemplary embodiment of the disclosure can take into account the access performance of the memory storage device and ensure the accuracy of the data.

The previously described exemplary embodiments of the present disclosure have the advantages aforementioned, wherein the advantages aforementioned not required in all versions of the present disclosure.

It will be apparent to those skilled in the art that various modifications and variations can be made to the structure of the disclosure without departing from the scope or spirit of the disclosure. In view of the foregoing, it is intended that the present disclosure cover modifications and variations of this disclosure provided they fall within the scope of the following claims and their equivalents.

What is claimed is:

1. A data writing method for a rewritable non-volatile memory module, the rewritable non-volatile memory module comprising a plurality of physical units, the plurality of physical units comprising a first physical unit and a second physical unit, the data writing method comprising:
writing first-type data into the first physical unit at a first write speed; and
writing second-type data into the second physical unit at a second write speed,
wherein the first-type data is different from the second-type data, and the first write speed is different from the second write speed.

2. The data writing method of claim 1, wherein the first write speed is greater than the second write speed.

3. The data writing method of claim 1, wherein the physical units are at least divided into a storage area and a system area, wherein the step of writing the first-type data into the first physical unit at the first write speed comprises:
writing the first-type data into the first physical unit belonging to the storage area, and
the step of writing the second-type data into the second physical unit at the second write speed comprises:
writing the second-type data into the second physical unit belonging to the system area.

4. The data writing method of claim 3, wherein the first-type data comprises user data from a host system, and the second-type data comprises management data for managing the rewritable non-volatile memory module.

5. The data writing method of claim 4, wherein the management data is used in one of a wear leveling operation, a bad block managing operation and a mapping table maintaining operation of the rewritable non-volatile memory module.

6. The data writing method of claim 2, wherein the first write speed and the second write speed differ by at least five times.

7. The data writing method of claim 1, wherein the step of writing the first-type data into the first physical unit at the first write speed comprises:
writing the first-type data into the first physical unit at the first write speed by using a first clock frequency, and
the step of writing the second-type data into the second physical unit at the second write speed comprises:
writing the second-type data into the second physical unit at the second write speed by using a second clock frequency, wherein the first clock frequency is different from the second clock frequency.

8. A memory storage device, comprising:
a connection interface unit configured to couple to a host system;
a rewritable non-volatile memory module comprising a plurality of physical units, the plurality of physical units comprising a first physical unit and a second physical unit; and
a memory control circuit unit, coupled to the connection interface unit and the rewritable non-volatile memory module,
wherein the memory control circuit unit is configured to write first-type data into the first physical unit at a first write speed,
wherein the memory control circuit unit is further configured to write second-type data into the second physical unit at a second write speed,
wherein the first-type data is different from the second-type data, and the first write speed is different from the second write speed.

9. The memory storage device of claim 8, wherein the first write speed is greater than the second write speed.

10. The memory storage device of claim 8, wherein the physical units are at least divided into a storage area and a system area, wherein the operation that the memory control circuit unit writes the first-type data into the first physical unit at the first write speed comprises:
writing the first-type data into the first physical unit belonging to the storage area, and
the operation that the memory control circuit unit writes the second-type data into the second physical unit at the second write speed comprises:
writing the second-type data into the second physical unit belonging to the system area.

11. The memory storage device of claim 10, wherein the first-type data comprises user data from the host system, and the second-type data comprises management data for managing the rewritable non-volatile memory module.

12. The memory storage device of claim 11, wherein the management data is used in one of a wear leveling operation, a bad block managing operation and a mapping table maintaining operation of the rewritable non-volatile memory module.

13. The memory storage device of claim 9, wherein the first write speed and the second write speed differ by at least five times.

14. The memory storage device of claim 8, wherein the operation that the memory control circuit unit writes the first-type data into the first physical unit at the first write speed comprises:
writing the first-type data into the first physical unit at the first write speed by using a first clock frequency, and
the operation that the memory control circuit unit writes the second-type data into the second physical unit at the second write speed comprises:
writing the second-type data into the second physical unit at the second write speed by using a second clock frequency, wherein the first clock frequency is different from the second clock frequency.

15. A memory control circuit unit for controlling a rewritable non-volatile memory module, the rewritable non-volatile memory module comprising a plurality of physical units, the plurality of physical units comprising a first physical unit and a second physical unit, the memory control circuit unit comprises:
a host interface, configured to couple to a host system,
a memory interface, configured to couple to the rewritable non-volatile memory module; and
a memory management circuit, coupled to the host interface and the memory interface;
wherein the memory management circuit is configured to write first-type data into the first physical unit at a first write speed,
wherein the memory management circuit is further configured to write second-type data into the second physical unit at a second write speed,
wherein the first-type data is different from the second-type data, and the first write speed is different from the second write speed.

16. The memory control circuit unit of claim 15, wherein the first write speed is greater than the second write speed.

17. The memory control circuit unit of claim 15, wherein the physical units are at least divided into a storage area and a system area, wherein the operation that the memory management circuit writes the first-type data into the first physical unit at the first write speed comprises:
writing the first-type data into the first physical unit belonging to the storage area, and
the operation that the memory management circuit writes the second-type data into the second physical unit at the second write speed comprises:
writing the second-type data into the second physical unit belonging to the system area.

18. The memory control circuit unit of claim 17, wherein the first-type data comprises user data from the host system, and the second-type data comprises management data for managing the rewritable non-volatile memory module.

19. The memory control circuit unit of claim 18, wherein the management data is used in one of a wear leveling operation, a bad block managing operation and a mapping table maintaining operation of the rewritable non-volatile memory module.

20. The memory control circuit unit of claim 16, wherein the first write speed and the second write speed differ by at least five times.

21. The memory control circuit unit of claim 15, wherein the operation that the memory management circuit writes the first-type data into the first physical unit at the first write speed comprises:
writing the first-type data into the first physical unit at the first write speed by using a first clock frequency, and
the operation that the memory management circuit writes the second-type data into the second physical unit at the second write speed comprises:
writing the second-type data into the second physical unit at the second write speed by using a second clock frequency, wherein the first clock frequency is different from the second clock frequency.
